(19) United States
(12) Patent Application Publication
(10) Pub. No.: US 2015/0210787 A1
(43) Pub. Date: Jul. 30, 2015

(54) Process for Producing Fluoroelastomers

(71) Applicant: E. I. DU PONT DE NEMOURS AND COMPANY, Wilmintong, DE (US)

(72) Inventor: Donald F Lyons, Wilmington, DE (US)

(21) Appl. No.: 14/428,674

(22) PCT Filed: Dec. 10, 2013
(86) PCT No.: PCT/US2013/073967

§ 371 Date: Mar. 17, 2015

Related U.S. Application Data
(60) Provisional application No. 61/738,554, filed on Dec. 18, 2012.

(51) Int. Cl. C08F 14/28; C08F 14/22; C08F 14/26

(52) U.S. Cl. CPC C08F 14/28; C08F 14/26; C08F 14/22

(57) ABSTRACT

An emulsion polymerization process for the production of fluoroelastomers is disclosed wherein the aqueous polymerization medium comprises a dispersed fluoroionomer particulate and is substantially free of dispersing agent.

### FIELD OF THE INVENTION

This invention pertains to an emulsion polymerization process for the production of fluoroelastomers wherein the aqueous polymerization medium comprises a particulate of fluorinated ionomer and wherein the medium is substantially free of dispersing agent.

### BACKGROUND OF THE INVENTION

Production of fluoroelastomers by emulsion and solution polymerization methods is well known in the art; see for example U.S. Pat. Nos. 4,214,060; 4,281,092; 6,512,063 and 6,774,164 B2. Generally, fluoroelastomers are produced in an emulsion polymerization process wherein a water-soluble polymerization initiator and a relatively large amount of dispersing agent (i.e. surfactant) are employed.

Use of emulsion polymerization enables the production of high molecular weight fluoroelastomers at a high polymerization rate and also provides an easy means for controlling the reaction temperature. However, typical surfactants, such as perfluorooctanoic acid, employed in the emulsion polymerization of fluoroelastomers are undesirable due to environmental and biopersistance concerns. Thus, development of a surfactant-free emulsion polymerization process for the manufacture of fluoroelastomers is desirable.

U.S. 2010/0160531 A1 discloses a fluoropolymer polymerization process wherein the combination of a particulate of fluorinated ionomer and a dispersing agent is employed in the reactor in order to achieve commercially useful polymerization rates. It would be more desirable if the polymerization process could be run at moderate polymerization rates without the presence of a dispersing agent (i.e. without a surfactant).

### SUMMARY OF THE INVENTION

One aspect of the present invention provides an emulsion polymerization process for the production of fluoroelastomers wherein the resulting fluoroelastomers are readily isolated from the emulsion. This emulsion polymerization process comprises polymerizing a first monomer selected from the group consisting of vinylidene fluoride and tetrafluoroethylene with at least one different monomer in an aqueous medium substantially free of dispersant, said aqueous medium comprising initiator and dispersed particulate of fluorinated ionomer to obtain an aqueous dispersion of fluoroelastomer.

### DETAILED DESCRIPTION OF THE INVENTION

The present invention is directed to an emulsion polymerization process for producing fluoroelastomers having a glass transition temperature of less than 20° C. The fluoroelastomer may be partially fluorinated or perfluorinated.

Fluoroelastomer polymers made by the process of this invention comprise copolymerized units of a first monomer selected from the group consisting of vinylidene fluoride and tetrafluoroethylene with and at least one different monomer.

Fluoroelastomers made by the process of this invention preferably contain between 25 to 70 weight percent, based on the total weight of the fluoroelastomer, of copolymerized units of a first monomer which may be vinylidene fluoride (VF₂), or tetrafluoroethylene (TFE). The remaining units in the fluoroelastomers are comprised of one or more additional copolymerized monomers, different from said first monomer, selected from the group consisting of fluoromonomers, hydrocarbon olefins and mixtures thereof. Fluoromonomers include fluorine-containing olefins and fluorine-containing vinyl ethers.

Fluorine-containing olefins which may be employed to make fluoroelastomers by the present invention include, but are not limited to vinylidene fluoride (VF₂), hexafluoropropylene (HFP), tetrafluoroethylene (TFE), 1,2,3,3,3-pentafluoropropene (1-HPFP), 1,1,3,3,3-pentafluoropropene (2-HPFP), chlorotrifluoroethylene (CTFE) and vinyl fluoride.

Fluorine-containing vinyl ethers that may be employed to make fluoroelastomers by the present invention include, but are not limited to perfluoro(alkyl vinyl) ethers. Perfluoro(alkyl vinyl) ethers (PAVE) suitable for use as monomers include those of the formula

CF₂═CFO(R_{f′}O)ₙ(R_{f″}O)ₘR_{f} (I)
where R_{f′} and R_{f″} are different linear or branched perfluoroalkylene groups of 2-6 carbon atoms, m and n are independently 0-10, and R_{f} is a perfluoroalkyl group of 1-6 carbon atoms.

A preferred class of perfluoro(alkyl vinyl) ethers includes compositions of the formula

CF₂═CFO(CF₂CFXO)ₙR_{f} (II)
where X is F or CF₃, n is 0-5, and R_{f} is a perfluoroalkyl group of 1-6 carbon atoms.

A most preferred class of perfluoro(alkyl vinyl) ethers includes those ethers wherein n is 0 or 1 and R_{f} contains 1-3 carbon atoms. Examples of such perfluorinated ethers include perfluoro(methyl vinyl ether) (PMVE), perfluoro(ethyl vinyl ether) (PEVE) and perfluoro(propyl vinyl ether) (PPVE). Other useful monomers include compounds of the formula

CF₂═CFO[(CF₂)ₘCF₂CFZO]ₙR_{f} (III)
where R_{f} is a perfluoroalkyl group having 1-6 carbon atoms,
m=0 or 1, n=0-5, and Z=F or CF₃. Preferred members of this class are those in which R_{f} is c₃F₇, m=0, and n=1.

Additional perfluoro(alkyl vinyl) ether monomers include compounds of the formula

CF₂═CFO[(CF₂CF{CF₃}O)ₙ(CF₂CF₂CF₂O)ₘ(CF₂)ₚ]CₓF₂ₓ₊₁ (IV)
where m and n independently=0-10, p=0-3, and x=1-5. Preferred members of this class include compounds where n=0-1, m=0-1, and x=1.

Other examples of useful perfluoro(alkyl vinyl ethers) include

CF₂═CFOCF₂CF(CF₃)O(CF₂O)ₘCₙF₂ₙ₊₁ (V)
where n=1-5, m=1-3, and where, preferably, n=1.

If copolymerized units of PAVE are present in fluoroelastomers prepared by the process of the invention, the PAVE content generally ranges from 25 to 75 weight percent, based on the total weight of the fluoroelastomer. If perfluoro(methyl vinyl ether) is used, then the fluoroelastomer preferably contains between 30 and 65 wt. % copolymerized PMVE units.

Hydrocarbon olefins useful in the fluoroelastomers prepared by the process of this invention include, but are not limited to ethylene and propylene. If copolymerized units of a hydrocarbon olefin are present in the fluoroelastomers prepared by the process of this invention, hydrocarbon olefin content is generally 4 to 30 weight percent.

The fluoroelastomers prepared by the process of the present invention may also, optionally, comprise units of one or more cure site monomers. Examples of suitable cure site monomers include, but are not limited to: i) bromine -containing olefins; ii) iodine-containing olefins; iii) bromine-containing vinyl ethers; iv) iodine-containing vinyl ethers; v) fluorine-containing olefins having a nitrile group; vi) fluorine-containing vinyl ethers having a nitrile group; vii) 1,1,3,3,3-pentafluoropropene (2-HPFP); viii) perfluoro(2-phenoxypropyl vinyl) ether; ix) carboxylic acid-containing fluorinated vinyl ethers; and x) non-conjugated dienes.

Brominated cure site monomers may contain other halogens, preferably fluorine. Examples of brominated olefin cure site monomers are CF₂═CFOCF₂CF₂CF₂OCF₂CF₂Br; bromotrifluoroethylene; 4-bromo-3,3,4,4-tetrafluorobutene-1 (BTFB); and others such as vinyl bromide, 1-bromo-2,2-difluoroethylene; perfluoroallyl bromide; 4-bromo-1,1,2-trifluorobutene-1;4-bromo-1,1,3,3,4,4,-hexafluorobutene; 4-bromo-3-chloro-1,1,3,4,4-pentafluorobutene; 6-bromo-5,5,6,6-tetrafluorohexene; 4-bromoperfluorobutene-1 and 3,3-difluoroallyl bromide. Brominated vinyl ether cure site monomers useful in the invention include 2-bromo-perfluoroethyl perfluorovinyl ether and fluorinated compounds of the class CF₂Br—R_{f}—O—CF═CF₂(R_{f} is a perfluoroalkylene group), such as CF₂BrCF₂O—CF═CF₂, and fluorovinyl ethers of the class ROCF═CFBr or ROCBr═CF₂ (where R is a lower alkyl group or fluoroalkyl group) such as CH₃OCF═CFBr or CF₃CH₂OCF═CFBr.

Suitable iodinated cure site monomers include iodinated olefins of the formula: CHR═CH—Z—CH₂CHR—I, wherein R is —H or —CH₃; Z is a C₁-C₁₈ (per)fluoroalkylene radical, linear or branched, optionally containing one or more ether oxygen atoms, or a (per)fluoropolyoxyalkylene radical as disclosed in U.S. Pat. No. 5,674,959. Other examples of useful iodinated cure site monomers are unsaturated ethers of the formula: I(CH₂CF₂CF₂)ₙOCF═CF₂ and ICH₂CF₂O[CF(CF₃)CF₂O]ₙCF═CF₂, and the like, wherein n=1-3, such as disclosed in U.S. Pat. No. 5,717,036. In addition, suitable iodinated cure site monomers including iodoethylene, 4-iodo-3,3,4,4-tetrafluorobutene-1 (ITFB); 3-chloro-4-iodo-3,4,4-trifluorobutene; 2-iodo-1,1,2,2-tetrafluoro-1-(vinyloxy)ethane; 2-iodo-1-(perfluorovinyloxy)-1,1,-2,2-tetrafluoroethylene; 1,1,2,3,3,3-hexafluoro-2-iodo-1-(perfluorovinyloxy)propane; 2-iodoethyl vinyl ether; 3,3,4,5,5,5-hexafluoro-4-iodopentene; and iodotrifluoroethylene are disclosed in U.S. Pat. No. 4,694,045. Allyl iodide and 2-iodo-perfluoroethyl perfluorovinyl ether are also useful cure site monomers.

Useful nitrile-containing cure site monomers include those of the formulas shown below.

CF₂═CF—O(CF₂)ₙ—CN (VI)
where n=2-12, preferably 2-6;

CF₂═CF—O[CF₂—CF(CF₃)—O]ₙ—CF₂—CF(CF₃)—CN (VII)
where n=0-4, preferably 0-2;

CF₂═CF—[OCF₂CF(CF₃)]ₓ—O—(CF₂)ₙ—CN (VIII)
where x=1-2, and n=1-4; and

CF₂═CF—O—(CF₂)ₙ—O—CF(CF₃)CN (IX)
where n=2-4. Those of formula (VIII) are preferred. Especially preferred cure site monomers are perfluorinated polyethers having a nitrile group and a trifluorovinyl ether group. A most preferred cure site monomer is

CF₂═CFOCF₂CF(CF₃)OCF₂CF₂CN (X)
i.e. perfluoro(8-cyano-5-methyl-3,6-dioxa-1-octene) or 8-CNVE.

Examples of non-conjugated diene cure site monomers include, but are not limited to 1,4-pentadiene; 1,5-hexadiene; 1,7-octadiene; 3,3,4,4-tetrafluoro-1,5-hexadiene; and others, such as those disclosed in CA 2,067,891, EP 0784064A1 and WO 2012018603. A suitable triene is 8-methyl-4-ethylidene-1,7-octadiene.

Of the cure site monomers listed above, preferred compounds, for situations wherein the fluoroelastomer will be cured with peroxide, include 4-bromo-3,3,4,4-tetrafluorobutene-1 (BTFB); 4-iodo-3,3,4,4-tetrafluorobutene-1 (ITFB); allyl iodide; bromotrifluoroethylene and a nitrile-containing cure site monomer such as 8-CNVE. When the fluoroelastomer will be cured with a polyol, 2-HPFP or perfluoro(2-phenoxypropyl vinyl) ether is the preferred cure site monomer. When the fluoroelastomer will be cured with a tetraamine, bis(aminophenol) or bis(thioaminophenol), a nitrile-containing cure site monomer (e.g. 8-CNVE) is the preferred cure site monomer. When the fluoroelastomer will be cured with ammonia or a compound that releases ammonia at curing temperatures (e.g. urea), a nitrile-containing cure site monomer (e.g. 8-CNVE) is the preferred cure site monomer.

Units of cure site monomer, when present in the fluoroelastomers manufactured by the process of this invention, are typically present at a level of 0.05-10 wt. % (based on the total weight of fluoroelastomer), preferably 0.05-5 wt. % and most preferably between 0.05 and 3 wt. %.

Specific fluoroelastomers which may be produced by the process of this invention include, but are not limited to those comprising copolymerized units of i) vinylidene fluoride and hexafluoropropylene; ii) vinylidene fluoride, hexafluoropropylene and tetrafluoroethylene; iii) vinylidene fluoride, hexafluoropropylene, tetrafluoroethylene and 4-bromo-3,3,4,4-tetrafluorobutene-1; iv) vinylidene fluoride, hexafluoropropylene, tetrafluoroethylene and 4-iodo-3,3,4,4-tetrafluorobutene-1; v) vinylidene fluoride, perfluoro(methyl vinyl ether), tetrafluoroethylene and 4-bromo-3,3,4,4-tetrafluorobutene-1; vi) vinylidene fluoride, perfluoro(methyl vinyl ether), tetrafluoroethylene and 4-iodo-3,3,4,4-tetrafluorobutene-1; vii) vinylidene fluoride, perfluoro(methyl vinyl ether), tetrafluoroethylene and 1,1,3,3,3-pentafluoropropene; viii) tetrafluoroethylene, perfluoro(methyl vinyl ether) and ethylene; ix) tetrafluoroethylene, perfluoro(methyl vinyl ether), ethylene and 4-bromo-3,3,4,4-tetrafluorobutene-1; x) tetrafluoroethylene, perfluoro(methyl vinyl ether), ethylene and 4-iodo-3,3,4,4-tetrafluorobutene-1; xi) tetrafluoroethylene, propylene and vinylidene fluoride; xii) tetrafluoroethylene and perfluoro(methyl vinyl ether); xiii) tetrafluoroethylene, perfluoro(methyl vinyl ether) and perfluoro(8-cyano-5-methyl-3,6-dioxa-1-octene); xiv) tetrafluoroethylene, perfluoro(methyl vinyl ether) and 4-bromo-3,3,4,4-tetrafluorobutene-1; xv) tetrafluoroethylene, perfluoro(methyl vinyl ether) and 4-iodo-3,3,4,4-tetrafluorobutene-1; xvi) tetrafluoroethylene, perfluoro(methyl vinyl ether) and perfluoro(2-phenoxypropyl vinyl) ether; and xvii) tetrafluoroethylene and propylene.

Additionally or instead of a copolymerized cure site monomer, iodine-containing endgroups, bromine-containing endgroups or mixtures thereof may optionally be present at one or both of the fluoroelastomer polymer chain ends as a result of the use of chain transfer or molecular weight regulating agents during preparation of the fluoroelastomers. The amount of chain transfer agent, when employed, is calculated to result in an iodine or bromine level in the fluoroelastomer in the range of 0.005-5 wt. %, preferably 0.05-3 wt. %.

Examples of chain transfer agents include iodine-containing compounds that result in incorporation of a bound iodine atom at one or both ends of the polymer molecules. Methylene iodide; 1,4-diiodoperfluoro-n-butane; and 1,6-diiodo-3,3,4,4,tetrafluorohexane are representative of such agents. Other iodinated chain transfer agents include 1,3-diiodoperfluoropropane; 1,6-diiodoperfluorohexane; 1,3-diiodo-2-chloroperfluoropropane; 1,2-di(iododifluoromethyl)-perfluorocyclobutane; monoiodoperfluoroethane; monoiodoerfluorobutane; 2-iodo-1-hydroperfluoroethane, etc. Also included are the cyano-iodine chain transfer agents disclosed in European Patent 0868447A1. Particularly preferred are diiodinated chain transfer agents.

Examples of brominated chain transfer agents include 1-bromo-2-iodoperfluoroethane; 1-bromo-3-iodoperfluoropropane; 1-iodo-2-bromo-1,1-difluoroethane and others such as disclosed in U.S. Pat. No. 5,151,492.

Other chain transfer agents suitable for use in the process of this invention include those disclosed in U.S. Pat. No. 3,707,529. Examples of such agents include isopropanol, diethylmalonate, ethyl acetate, carbon tetrachloride, acetone and dodecyl mercaptan.

Cure site monomers and chain transfer agents may be added to the reactor neat or as solutions. In addition to being introduced into the reactor near the beginning of polymerization, quantities of chain transfer agent may be added throughout the entire polymerization reaction period, depending upon the desired composition of the fluoroelastomer being produced, the chain transfer agent being employed, and the total reaction time.

Particulate of fluorinated ionomer is employed in the process in accordance with the present invention. “Fluorinated Ionomer” means a fluoropolymer having sufficient ionic groups to provide an ion exchange ratio of no greater than about 53. In this application, “ion exchange ratio” or “IXR” is defined as number of carbon atoms in the polymer backbone in relation to the ionic groups. Precursor groups such as —SO₂F which upon hydrolysis become ionic are not treated as ionic groups for the purposes of determining IXR. The fluorinated ionomer employed in the process of the invention preferably has an ion exchange ratio of about 3 to about 53. More preferably, the IXR is about 3 to about 43, even more preferably about 3 to about 33, still more preferably about 8 to about 33, most preferably 8 to about 23. In a preferred embodiment, the fluorinated ionomer is highly fluorinated. “Highly fluorinated” in reference to ionomer means that at least 90% of the total number of univalent atoms bonded to carbon atoms in the polymer are fluorine atoms. Most preferably, the ionomer is perfluorinated.

In fluorinated ionomers, the ionic groups are typically distributed along the polymer backbone. Preferably, the fluorinated ionomer comprises a polymer backbone with recurring side chains attached to the backbone with the side chains carrying the ionic groups. Preferred fluorinated ionomer comprises ionic groups having a pKa less than about 10, more preferably, less than about 7. Ionic groups of the polymer are preferably selected from the group consisting of sulfonate, carboxylate, phosphonate, phosphate, and mixtures thereof. The terms “sulfonate, carboxylate, phosphonate and phosphate” are intended to refer to either the respective salts or respective acids from which salts can be formed. Preferably, when salts are employed, the salts are alkali metal or ammonium salts. Most preferably, the fluorinated ionomer is used in its acid form. Preferred ionic groups are sulfonate groups. Sulfonate groups in preferred fluorinated ionomers used in the process of the invention have a pKa of about 1.9 as measured on the fluorinated ionomer in aqueous dispersion form having 10 wt % solids at room temperature.

Various known fluorinated ionomers can be used including polymers and copolymers of trifluoroethylene, tetrafluoroethylene (TFE), α,β,β-trifluorostyrene, etc., into which ionic groups have been introduced. α,β,β-trifluorostyrene polymers useful for the practice of the invention are disclosed in U.S. Pat. No. 5,422,411. Possible polymers include homopolymers or copolymers of two or more monomers. Copolymers are typically formed from one monomer which is a nonfunctional monomer and which provides carbon atoms for the polymer backbone. A second monomer provides both carbon atoms for the polymer backbone and also contributes the side chain carrying the ionic group or its precursor, e.g., a sulfonyl fluoride group (—SO₂F), which can be subsequently hydrolyzed to a sulfonate functional group. For example, copolymers of a first fluorinated vinyl monomer together with a second fluorinated vinyl monomer having a sulfonyl fluoride group (—So₂F) can be used. Possible first monomers include tetrafluoroethylene (TFE), hexafluoropropylene, vinyl fluoride, vinylidine fluoride, trifluoroethylene, chlorotrifluoroethylene, perfluoro (alkyl vinyl ether), and mixtures thereof. Possible second monomers include a variety of fluorinated vinyl ethers with ionic groups or precursor groups which can provide the desired side chain in the polymer. The first monomer may also have a side chain. Additional monomers can also be incorporated into these polymers if desired.

A class of preferred ionomers for use in the present invention includes a highly fluorinated, most preferably perfluorinated, carbon backbone and the side chain is represented by the formula

—(O—CF₂CFR_{f})ₐ—(O—CF₂)_{b}—(CFR′_{f})_{c}SO₃X,
wherein R_{f} and R′_{f} are independently selected from F, Cl or a perfluorinated alkyl group having 1 to 10 carbon atoms, a=0 to 2, b=0 to 1, c=0 to 6, and X is H, Li, Na, K or NH₄. The preferred ionomers include, for example, polymers disclosed in U.S. Pat. No. 3,282,875 and in U.S. Pat. Nos. 4,358,545 and 4,940,525. One preferred ionomer comprises a perfluorocarbon backbone and the side chain is represented by the formula —O—CF₂CF(CF₃)—O—CF₂CF₂SO₃X, wherein X is as defined above. Ionomers of this type are disclosed in U.S. Pat. No. 3,282,875 and can be made by copolymerization of tetrafluoroethylene (TFE) and the perfluorinated vinyl ether CF₂═CF—O—CF₂CF(CF₃)—O—CF₂CF₂SO₂F, perfluoro(3,6-dioxa-4-methyl-7-octenesulfonyl fluoride) (PDMOF), followed by conversion to sulfonate groups by hydrolysis of the sulfonyl fluoride groups and ion exchanging if needed to convert to the desired form. One preferred ionomer of the type disclosed in U.S. Pat. Nos. 4,358,545 and 4,940,525 has the side chain —O—CF₂CF₂SO₃X, wherein X is as defined above. This ionomer can be made by copolymerization of tetrafluoroethylene (TFE) and the perfluorinated vinyl ether CF₂═CF—O—CF₂CF₂SO₂F, perfluoro(3-oxa-4-pentenesulfonyl fluoride) (POPF), followed by hydrolysis and acid exchange if needed.

For ionomers of this type, the cation exchange capacity of a polymer is often expressed in terms of equivalent weight (EW). For the purposes of this application, equivalent weight (EW) is defined to be the weight of the ionomer in acid form required to neutralize one equivalent of NaOH. In the case of a sulfonate ionomer where the ionomer comprises a perfluorocarbon backbone and the side chain is
—O—CF₂—CF(CF₃)—O—CF₂—CF₂—SO₃H (or a salt thereof), the equivalent weight range which corresponds to an IXR of about 8 to about 23 is about 750 EW to about 1500 EW. IXR for this ionomer can be related to equivalent weight using the following formula: 50 IXR+344=EW. While generally the same IXR range is used for sulfonate ionomers disclosed in U.S. Pat. Nos. 4,358,545 and 4,940,525, e.g., the ionomer having the side chain —O—CF₂CF₂SO₃H (or a salt thereof), the equivalent weight is somewhat lower because of the lower molecular weight of the monomer unit containing the ionic group. For the preferred IXR range of about 8 to about 23, the corresponding equivalent weight range is about 575 EW to about 1325 EW. IXR for this polymer can be related to equivalent weight using the following formula: 50 IXR+178=EW.

The molecular weight of the fluorinated ionomer particulate can generally be in the same range as the resin which is used in ion exchange polymer membranes used in the chloralkali process for the electrolytic production of chlorine and sodium hydroxide from sodium chloride and in fuel cells. Such fluorinated ionomer resin has a molecular weight which preferably provides solid fluorinated ionomer particulate at room temperature. In thermoplastic forms of the fluorinated ion exchange polymer, melt flow rate is preferably in the range of 1 to about 500, more preferably about 5 to about 50, most preferably about 10 to about 35 g/10 min.

The fluorinated ionomer particulate of the dispersion employed in accordance with the process of the invention preferably has a weight average particle size of about 2 nm to about 100 nm. More preferably, such particulate has a weight average particle size of about 2 to about 50 nm, even more preferably about 2 to about 30, still more preferably about 2 to about 10 nm. A suitable preparation method for aqueous dispersions of such fluorinated ionomer particulate is taught in U.S. Pat. Nos. 6,552,093 and 7,166,685 (Curtin et al.). The preparation method of Curtin et al. can provide “water only” aqueous dispersions. “Water only” means the aqueous dispersions contain a liquid medium which contains either no other liquids other than water or, if other liquids are present, no more that about 1 wt %, of such liquids.

The weight average particle size in a liquid dispersion of fluorinated ionomer particulate used in accordance with the invention can be measured by a dynamic light scattering (DLS) technique as described below in the Test Methods.

In accordance with the invention, dispersed fluorinated ionomer particulate is preferably provided in the aqueous polymerization medium by mixing a concentrated aqueous dispersion or dispersible powder of the fluorinated ionomer into the aqueous polymerization medium. Preferred concentrated aqueous dispersions for use in accordance with the invention are preferably the “water only” aqueous dispersions described above made as taught in U.S. Pat. Nos. 6,552,093 and 7,166,685 (Curtin et al.). Solids levels in such concentrates are preferably about 1 to about 35 wt %, more preferably about 5 to about 35 wt %. Aqueous dispersions made as disclosed in U.S. Pat. Nos. 6,552,093 and 7,166,685 B2 (Curtin et al.) can also be dried to form powders which are readily redispersed in water or various polar organic solvents to provide dispersions in such solvents. While dispersions of fluorinated ionomer particulate in polar organic solvents may be useful in the practice of the invention, such solvents are usually telogenic and it is generally preferred to employ aqueous dispersions of the fluorinated ionomer in the practice of the present invention with low amounts or no organic solvents present. Thus, dried powders of the dispersions made according to U.S. Pat. Nos. 6,552,093 and 7,166,685 B2 (Curtin et al.) can be introduced directly into the aqueous polymerization medium or mixed with water to produce a concentrated aqueous dispersion prior to such introduction to provide the dispersion of fluorinated ionomer particulate. Concentrated aqueous dispersions, whether made directly from the process as disclosed in U.S. Pat. Nos. 6,552,093 and 7,166,685 B2 (Curtin et al.) or made from dried powders, can be produced and stored at concentrations up to 35 wt % solids, are stable for long periods, and can be diluted to any desired concentration with water.

Suitable fluorinated ionomer dispersions may also be available in, for example, mixed solvents of water and lower alcohols as disclosed in U.S. Pat. Nos. 4,443,082 (Grot). The alcohol content of such dispersions may be reduced or substantially removed using, for example, a rotary evaporator.

The amount of fluorinated ionomer particulate that is dispersed in the polymerization medium is typically 0.01 to 1.0 wt %.

The aqueous polymerization medium is substantially free of conventional dispersing agents. That is the aqueous polymerization medium comprises less than 1 wt % dispersant, preferably less than 0.5 wt % dispersant, most preferably 0 wt % dispersant. By “conventional dispersing agent” is meant a nonionic or ionic surfactant such as a hydrocarbon surfactant or a fluorosurfactant that is added to the polymerization medium. Small amounts of dispersing agents may be produced during the polymerization of the monomers due to interaction of polymerization initiator with monomers or polymers being formed. However, this type of dispersing agent is not included in the term “conventional dispersing agent”.

The emulsion polymerization process of this invention may be a continuous, semi-batch or batch process. A semi-batch process is preferred.

In the semi-batch emulsion polymerization process of this invention, a gaseous monomer mixture of a desired composition (initial monomer charge) is introduced into a reactor which contains an aqueous polymerization medium precharge. The reactor is typically not completely filled with the aqueous medium, so that a vapor space remains. The aqueous medium comprises a dispersion of particulate fluoroionomer and is substantially free of dispersing agent. Optionally, the aqueous medium may contain a pH buffer, such as a phosphate or acetate buffer for controlling the pH of the polymerization reaction. Instead of a buffer, a base, such as NaOH may be used to control pH. Preferably, polymerization is conducted in the absence of buffer or inorganic electrolytes. Alternatively, or additionally, pH buffer or base may be added to the reactor at various times throughout the polymerization reaction, either alone or in combination with other ingredients such as polymerization initiator, liquid cure site monomer, or chain transfer agent. Also optionally, the initial aqueous polymerization medium may contain a water-soluble inorganic peroxide polymerization initiator.

The initial monomer charge contains a quantity of a first monomer of either TFE or VF₂ and also a quantity of one or more additional monomers which are different from the first monomer. The amount of monomer mixture contained in the initial charge is set so as to result in a reactor pressure between 0.5 and 10 MPa.

The monomer mixture is dispersed in the aqueous medium and, optionally, a chain transfer agent may also be added at this point while the reaction mixture is agitated, typically by mechanical stirring. In the initial gaseous monomer charge, the relative amount of each monomer is dictated by reaction kinetics and is set so as to result in a fluoroelastomer having the desired ratio of copolymerized monomer units (i.e. very slow reacting monomers must be present in a higher amount relative to the other monomers than is desired in the composition of the fluoroelastomer to be produced).

The temperature of the semi-batch reaction mixture is maintained in the range of 25° C.-130° C., preferably 50° C.-100° C. Polymerization begins when the initiator either thermally decomposes or reacts with reducing agent and the resulting radicals react with dispersed monomer.

Additional quantities of the gaseous monomer(s) and optional cure site monomer (incremental feed) are added at a controlled rate throughout the polymerization in order to maintain a constant reactor pressure at a controlled temperature. The relative ratio of monomers contained in the incremental feed is set to be approximately the same as the desired ratio of copolymerized monomer units in the resulting fluoroelastomer. Thus, the incremental feed contains between 25 to 70 weight percent, based on the total weight of the monomer mixture, of a first monomer of either TFE or VF₂ and 75 to 30 weight percent total of one or more additional monomers that are different from the first monomer. Chain transfer agent may also, optionally, be introduced into the reactor at any point during this stage of the polymerization. Additional polymerization initiator may also be fed to the reactor during this stage. The amount of polymer formed is approximately equal to the cumulative amount of incremental monomer feed. One skilled in the art will recognize that the molar ratio of monomers in the incremental feed is not necessarily exactly the same as that of the desired (i.e. selected) copolymerized monomer unit composition in the resulting fluoroelastomer because the composition of the initial charge may not be exactly that required for the selected final fluoroelastomer composition, or because a portion of the monomers in the incremental feed may dissolve into the polymer particles already formed, without reacting. Polymerization times in the range of from 2 to 30 hours are typically employed in this semi-batch polymerization process.

The continuous emulsion polymerization process of this invention differs from the semi-batch process in the following manner. The reactor is completely filled with aqueous medium so that there is no vapor space. Gaseous monomers and solutions of other ingredients such as water-soluble monomers, chain transfer agents, buffer, bases, polymerization initiator, etc., are fed to the reactor in separate streams at a constant rate. Feed rates are controlled so that the average polymer residence time in the reactor is generally between 0.2 to 4 hours. Short residence times are employed for reactive monomers, whereas less reactive monomers such as perfluoro(alkyl vinyl) ethers require more time. The temperature of the continuous process reaction mixture is maintained in the range of 25° C.-130° C., preferably 70° C.-120° C.

In the process of this invention, the polymerization temperature is maintained in the range of 25°-130° C. If the temperature is below 25° C., the rate of polymerization is too slow for efficient reaction on a commercial scale, while if the temperature is above 130° C., the reactor pressure required in order to maintain polymerization is too high to be practical.

The polymerization pressure is controlled in the range of 0.5 to 10 MPa, preferably 1 to 6.2 MPa. In a semi-batch process, the desired polymerization pressure is initially achieved by adjusting the amount of gaseous monomers in the initial charge, and after the reaction is initiated, the pressure is adjusted by controlling the incremental gaseous monomer feed. In a continuous process, pressure is adjusted by means of a back-pressure regulator in the dispersion effluent line. The polymerization pressure is set in the above range because if it is below 1 MPa, the monomer concentration in the polymerization reaction system is too low to obtain a satisfactory reaction rate. In addition, the molecular weight does not increase sufficiently. If the pressure is above 10 MPa, the cost of the required high pressure equipment is very high.

To achieve the fastest polymerization rates, the fluorinated ionomer is preferably used in its acidic state and the aqueous medium is preferably substantially free of any electrolytes or buffers prior to introduction of a free radical initiator. The ionic strength, l, of a solution is defined as

l=½(m₊z₊²+m.z.²)
where m₊ is the molality of positively charged ions in moles of ion per kilogram of solvent, z₊ is the charge of any positively charged ion, m. is the molality of negatively charged ions in moles of ion per kilogram of solvent, and z. is the charge of any negatively charged ion (Atkins, P. W. Physical Chemistry, W. H. Freeman and Co., 1978, p. 319). Excluding any contribution from the fluorinated ionomer, the ionic strength of the aqueous medium is preferably less than 0.025, more preferably less than 0.005 and most preferably zero.

In a semi-batch emulsion polymerization process, the aqueous medium should preferably only contain fluorinated ionomer in its acidic state, water, optional liquid monomers, and optional solvents before initiator is fed to the reactor. Once polymerization has commenced, buffers and other water soluble compounds may be fed to the reactor if desired. Alternatively, the initiator solution may itself contain buffers or other pH regulating substances. In a continuous emulsion polymerization process, an aqueous solution containing initiator, buffer, electrolyte, or pH regulator should be fed to the reactor separately from an aqueous solution containing the fluorinated ionomer in its acidic state.

The process of this invention is particularly suitable for the copolymerization of at least one liquid monomer with VF₂ or TFE. It is difficult to achieve high conversion of liquid monomers in fluoroelastomers and much unreacted monomer typically remains after polymerization. The process of this invention enables good incorporation of expensive liquid monomers into the fluoroelastomer.

The amount of fluoroelastomer formed is approximately equal to the amount of incremental feed charged, and is in the range of 10-35 parts by weight of fluoroelastomer per 100 parts by weight of aqueous emulsion, preferably in the range of 20-30 parts by weight of the fluoroelastomer. The degree of fluoroelastomer formation is set in the above range because if it is less than 10 parts by weight, productivity is undesirably low, while if it is above 35 parts by weight, the solids content becomes too high for satisfactory stirring.

Water-soluble peroxides which may be used to initiate polymerization in this invention include, for example, the ammonium, sodium or potassium salts of hydrogen persulfate. In a redox-type initiation, a reducing agent such as sodium sulfite, is present in addition to the peroxide. Other redox type initiations are described in WO 2012150253 and WO 2012150256. These water-soluble peroxides may be used alone or as a mixture of two or more types. The amount to be used is selected generally in the range of 0.01 to 0.4 parts by weight per 100 parts by weight of polymer, preferably 0.05 to 0.3. During polymerization some of the fluoroelastomer polymer chain ends are capped with fragments generated by the decomposition of these peroxides.

Optionally, fluoroelastomer gum or crumb may be isolated from the fluoroelastomer dispersions produced by the process of this invention by the addition of a coagulating agent to the dispersion. Any coagulating agent known in the art may be used. Preferably, either a monovalent, divalent, or trivalent cation, or an acid is employed as the coagulant. The advantage of employing an acid as coagulating agent is that the resulting isolated fluoroelastomer will contain much lower metals than if a metal cation is employed as coagulating agent.

Common coagulants include, but are not limited to aluminum salts (e.g. potassium aluminum sulfate), calcium salts (e.g. calcium nitrate), magnesium salts (e.g. magnesium sulfate), or mineral acids (e.g. nitric acid). Also sodium chloride or potassium chloride, or a quaternary ammonium salt may be employed.

Instead of employing a coagulant, fluoroelastomers produced by this invention may be mechanically or freeze-thaw coagulated.

The fluoroelastomers prepared by the process of this invention are useful in many industrial applications including seals, wire coatings, tubing and laminates.

What is claimed is:

1. An emulsion polymerization process for the production of a fluoroelastomer, said process comprising polymerizing a first monomer selected from the group consisting of vinylidene fluoride and tetrafluoroethylene with at least one different monomer in an aqueous medium substantially free of dispersant, said aqueous medium comprising initiator and dispersed particulate of fluorinated ionomer to obtain an aqueous dispersion of fluoroelastomer.

2. The process of claim 1 wherein said at least one different monomer is selected from the group consisting of fluoromonomers, hydrocarbon olefins and mixtures thereof.

3. The process of claim 1 wherein said fluoroelastomer comprises copolymerized units selected from the group consisting of i) vinylidene fluoride and hexafluoropropylene; ii) vinylidene fluoride, hexafluoropropylene and tetrafluoroethylene; iii) vinylidene fluoride, hexafluoropropylene, tetrafluoroethylene and 4-bromo-3,3,4,4-tetrafluorobutene-1; iv) vinylidene fluoride, hexafluoropropylene, tetrafluoroethylene and 4-iodo-3,3,4,4-tetrafluorobutene-1; v) vinylidene fluoride, perfluoro(methyl vinyl ether), tetrafluoroethylene and 4-bromo-3,3,4,4-tetrafluorobutene-1; vi) vinylidene fluoride, perfluoro(methyl vinyl ether), tetrafluoroethylene and 4-iodo-3,3,4,4-tetrafluorobutene-1; vii) vinylidene fluoride, perfluoro(methyl vinyl ether), tetrafluoroethylene and 1,1,3,3,3-pentafluoropropene; viii) tetrafluoroethylene, perfluoro(methyl vinyl ether) and ethylene; ix) tetrafluoroethylene, perfluoro(methyl vinyl ether), ethylene and 4-bromo-3,3,4,4-tetrafluorobutene-1; x) tetrafluoroethylene, perfluoro(methyl vinyl ether), ethylene and 4-iodo-3,3,4,4-tetrafluorobutene-1; xi) tetrafluoroethylene, propylene and vinylidene fluoride; xii) tetrafluoroethylene and perfluoro(methyl vinyl ether); xiii) tetrafluoroethylene, perfluoro(methyl vinyl ether) and perfluoro(8-cyano-5-methyl-3,6-dioxa-1-octene); xiv) tetrafluoroethylene, perfluoro(methyl vinyl ether) and 4-bromo-3,3,4,4-tetrafluorobutene-1; xv) tetrafluoroethylene, perfluoro(methyl vinyl ether) and 4-iodo-3,3,4,4-tetrafluorobutene-1; xvi) tetrafluoroethylene, perfluoro(methyl vinyl ether) and perfluoro(2-phenoxypropyl vinyl) ether; and xvii) tetrafluoroethylene and propylene.

4. The process of claim 1 wherein said process is a semi-batch process.

5. The process of claim 1 wherein said aqueous medium has an ionic strength, excluding any contribution from the fluorinated ionomer, and prior to introduction of initiator, of less than 0.025.

6. The process of claim 5 wherein said aqueous medium has an ionic strength, excluding any contribution from the fluorinated ionomer, and prior to introduction of initiator, of less than 0.005.
